(19) United States
(12) Patent Application Publication
(10) Pub. No.: US 2017/0052267 A1
(43) Pub. Date: Feb. 23, 2017

(54) Fourier Domain LOCKIN Imaging for high accuracy and low signal Continuous Wave Sounding

(71) Applicant: Grant Matthews, Fort Wayne, IN (US)

(72) Inventor: Grant Matthews, Fort Wayne, IN (US)

(21) Appl. No.: 14/828,705

(22) Filed: Aug. 18, 2015

(51) Int. Cl. G01V 1/00; G01V 8/02

(52) U.S. Cl. CPC G01V 1/005; G01V 8/02

(57) ABSTRACT

Presented is an alternative method for sounding an unknown medium with active signals such as light or sound. Using specific design of both the emitted sounding signal and sampling periods, an effective multi-frequency LOCKIN imaging technique is demonstrated. In an example simulation of an atmospheric LIDAR system, the resolution and accuracy of the method is shown to be limited primarily by the quantity of data analyzed (rather than signal design or strength). This enables a sounding accuracy superior to that from expensive and often damaging pulse systems, yet with an order of magnitude less power required for the instrumentation.

### FIELD OF THE INVENTION

The present invention relates to the field sounding a medium using a continuous wave signal for example of light or sound. More specifically, the present invention relates to using a digital form of a LOCKIN amplifier to image the medium at any desired level of accuracy for a minimal amount of power, limited only by the bandwidth theorem.

### BACKGROUND OF THE INVENTION

The process of active sounding is used in fields such as seismic imaging and LIDAR probing of Earth's atmosphere. These techniques involve transmitting a wave S(t)[4], typically made of sound or light, and receiving the returned signal reflected from the medium[7] to be sounded (see FIG. 1)

### OBJECTS OF THE INVENTION

It is an initial objective of this invention to continuous wave sounding signal that enables high quality imaging of a medium[7] with low power requirements in a system displayed by FIG. 1. This must operate without the need to use a pulse wave, requiring far lower energy requirements in the transducer used. The technique is applicable to seismic and LIDAR sounding systems.

Still further, other objects and advantages of the invention with respect to high quality sounding of a medium will be apparent from the specification and drawings.

### SUMMARY OF THE INVENTION

A new type of continuous wave signal is described that allows a Fourier domain LOCKIN imaging of the medium to be probed. Based on the theory of the LOCKIN amplifier the invention allows digital signal processing to be used to sound a medium such as the ground or the atmosphere where accuracy is limited only by the bandwidth theorem.

The invention accordingly comprises the several steps transmitting[1] a signal[4] of light or sound into a medium to be probed[7]. Reflection from this medium is then received by two separate detectors[2][3] as displayed in FIG. 1. Careful design of the transmitted continuous wave signal allows highly accurate imaging of the medium[7] with far lower power than required by typical existing pulse systems. The combinations of elements and arrangement of parts that are adapted to affect such steps will be exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 Diagram of LIDAR or seismic sounding system[1] to probe medium[7] with reflectivity R(t), sending signal S(t)[4] and recording[6] return of R(t) S(t)[8]. This setup records return V(t) with a primary detector (black[3]) and samples the output ν(t) with a reference detector (white[2]), both mounted on a rotating gimbal[5] that can be used to exchange the positions of the two for calibration purposes;

FIG. 2 (a) Series of pulse signals of Gaussian shape and separated by time interval Δt (see Sₚ(t) of Eqn. 2). (b) Swept chirp pulse from Eqn. 3 with linearly varying frequency and Gaussian amplitude envelope. (c) Example of medium profile R(t) with two distinct reflecting surfaces to be resolved. (d) Example of returned pulse signal from two reflection profile R(t), where the pulse width is narrow enough to accurately resolve amplitudes of the two reflectors. (e) Example of returned swept chirp signal from two reflection profile R(t), where no direct resolution of reflectors can be made. (f) Auto-correlation of the returned swept chirp signal with the known outputted waveform (Eqn. 3), allowing resolution of reflectors. Legends are: Pulses[9], Pulse width[10], Gaussian envelope[11], Chirp pulse[12], Reflections[13], Amplitudes[14], No resolution[15], In-accuracy[16], False reflections[17];

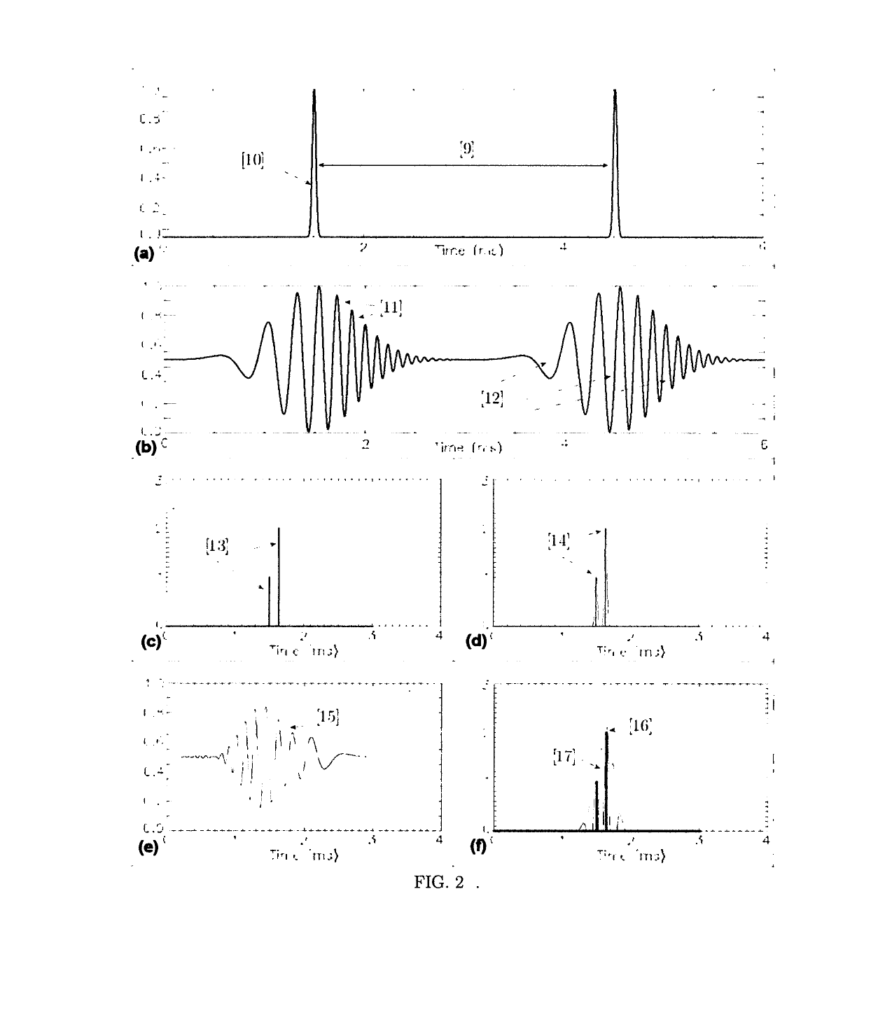

FIG. 3 Fourier domain analysis of LOCKIN imaging signal V(τ) from Eqn. 35. The different frequencies in the signal S_{cw}(t) are shown as spikes, each separated by gap Δω and the dashed arrowed illustration shows the operation of the LOCKIN technique which selects only the spikes and sets all noise in-between to a value of zero. Legends are: Noise[18], Dead zones[19];

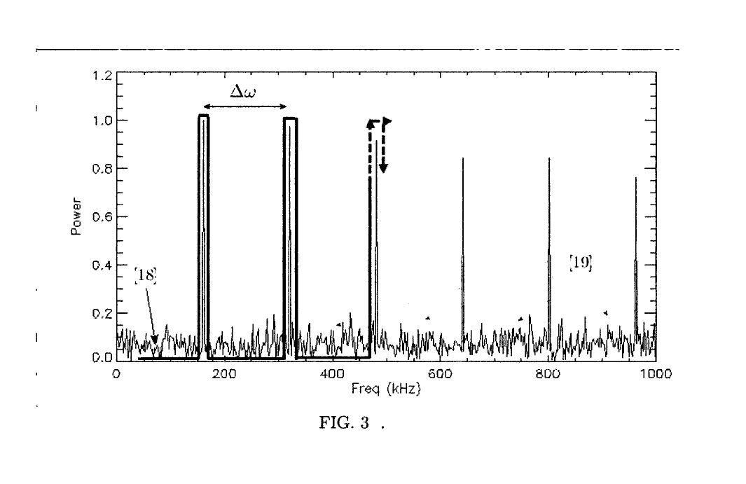

FIG. 4 (a) Left: Example clean LIDAR swept chirp signal S_{ch}(t) with frequency ranged from 0.2-1 MHz. Right: Frequency content of chirp signal S_{ch}(t) when extrinsic noise of SNR 1 is added. (b) Left: Example clean pulse signal Sₚ(t) with a peak power required to be 15-20 times that of a CW signal. Right: Frequency content of pulse signal Sₚ(t) when equivalent extrinsic CW noise is added. (c) Left: Example clean LOCKIN imaging LIDAR signal S(t) with frequency ranged up to 1 MHz in Δω steps. Right: Frequency content of LOCKIN imaging LIDAR signal S_{cw}(t) when extrinsic noise of SNR 1 is added;

FIG. 5 (a) Example auto-correlation function a(t) for chirp signal S_{ch}(t) from FIG. (b). (b) Raw result Zⱼ of LOCKIN imaging de-convolution, where a space clamp is used to identify the zero frequency component \overline{{Zⱼ}}_{space} of the reflective signal R(t). (c) Comparison of the perfect reflection profile R(t) with that derived using chirped, pulsed and LOCKIN imaging techniques. Legend: Space clamp[20], True Reflection R(t)[21], Chirp CW Method[22], Pulse Method[23], Zedika LOCKIN Method[24]; and

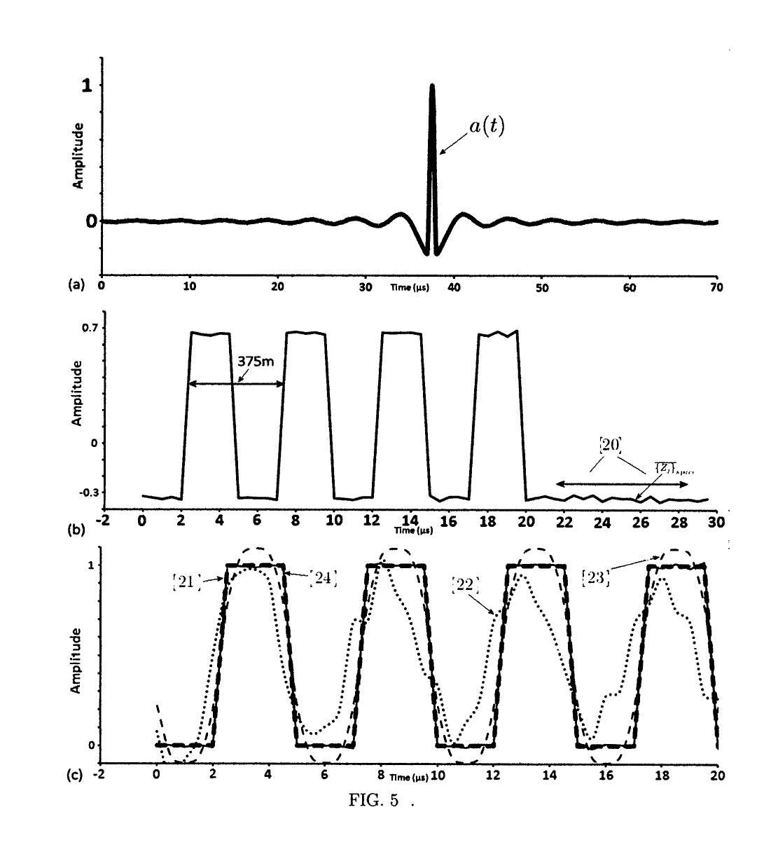

FIG. 6 Left: Examples of chirped, pulsed and LOCKIN soundings of a 375 m thick checkerboard medium by LIDAR. Sensor is moving at 7.5 km/s with an extrinsic SNR of 1. Right: The percent error in the retrieved profiles.

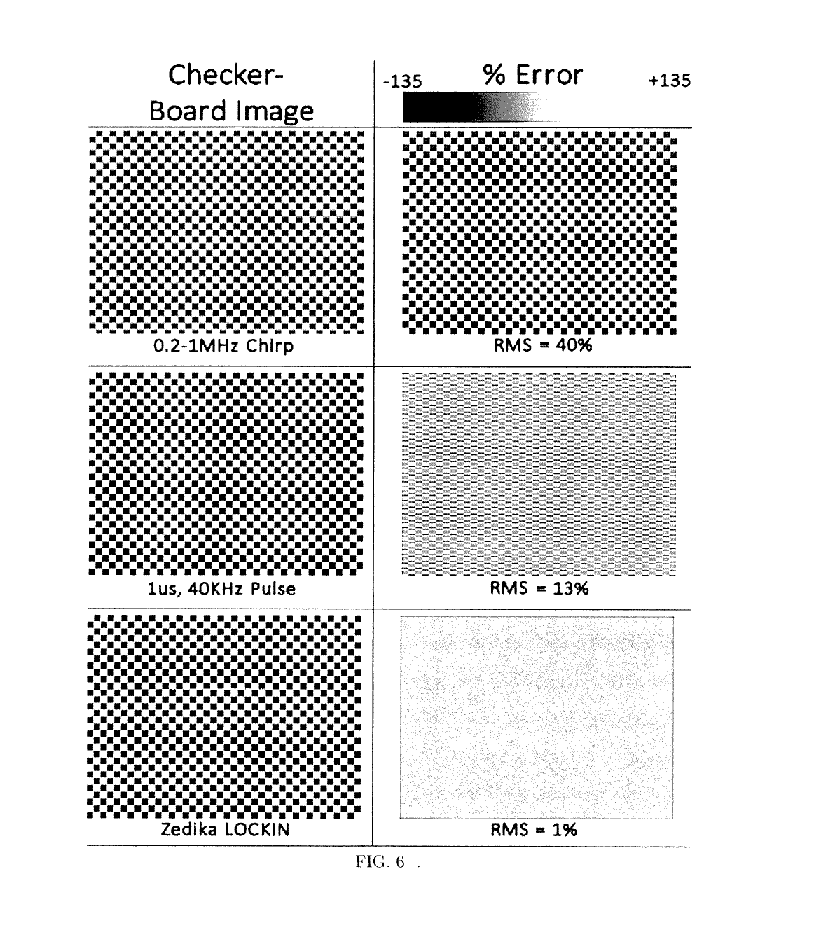

### DETAILED DESCRIPTION OF THE PREFERRED EMBODIMENTS

In the case of LIDAR, where a laser is being transmitted to the surface from high above Earth, there will be a signal return V(t) from many reflective targets R(t) throughout the depth of the atmosphere (i.e. Eqn. 1). For sound in the field of seismics, it will be scattering from solid mediums of differing sonic impedance. This return signal V(t) will therefore be the time convolution of the wanted reflective distribution R(t) with the active signal S(t) transmitted into it (multiplied by instrument gain G):

$$\begin{matrix}V ( t ) = G \times R ( t ) ⊗ S ( t ) & ( 1 ) \\ {S}_{p} ( t ) = B {\sum }_{n = 1}^{N} {e}^{- {α ( t - n Δ t )}^{2}} & ( 2 ) \\ {S}_{ch} ( t ) = C {\sum }_{n = 1}^{N} {e}^{- {γ ( t - n Δ t )}^{2}} cos \{ [ {μ}_{n} t + {κ}_{n} ] \times t \} & ( 3 )\end{matrix}$$

A direct way to sound the medium is to make the active signal S(t) a series of effective pulses as in Eqn. 2, each of very short time duration α⁻². As the pulses are made shorter, they approach the form of a series of Dirac delta functions which are separated by time duration Δt (see FIG. (a)). This will cause the return signal V(t) from Eqn. 1 to mirror the exact pattern of R(t) (i.e. the form of FIG. (d), closely matching the form of R(t) in FIG. (c), which shall also later repeat every Δt seconds). An optimal sounding signal could hence be a series of pulses separated by time Δt (where the interval choice would depend on the speed of the wave travelling in the medium of interest). However, practically creating such pulses is challenging in the field of engineering since it requires either the use of explosions for sound, or powerful pulse lasers for light (which in the case of space based platforms, also increases cost and limits the mission life). In the fields of oil exploration and Earth observation, technological and environmental factors make the use of pulsed sounding impractical.

A more achievable option is the use of a continuous wave (CW) system. For seismics this would allow use of piezo-electric transducers and for LIDAR, utilization could be made of reliable and cheap semi-conductor laser modulators (as are used widely in the telecommunication industry). However, the disadvantage of such systems is the need to design an appropriate spread in CW signal modulation frequency content (e.g. for seismic imaging this is needed to ensure both high penetration and spatial resolution). Eqn. 3 gives such an example of a Chirp signal modulated within a Gaussian envelope. A standard CW technique to resolve different reflective targets in a medium is then to auto-correlate a return signal with a pre-stored complex conjugate example of that transmitted (as in Eqn. 4 below and see FIG. (e) for an example chirp return signal:

$$\begin{matrix}\begin{matrix}{𝒳}_{ch} ( t ) = V ( t ) ⊗ {{S}_{ch} ( t )}^{*} & \\ = G \times R ( t ) ⊗ a ( t ) & ( 5 )\end{matrix} & ( 4 ) \\ a ( t ) = {S}_{ch} ( t ) ⊗ {{S}_{ch} ( t )}^{*} & ( 6 )\end{matrix}$$

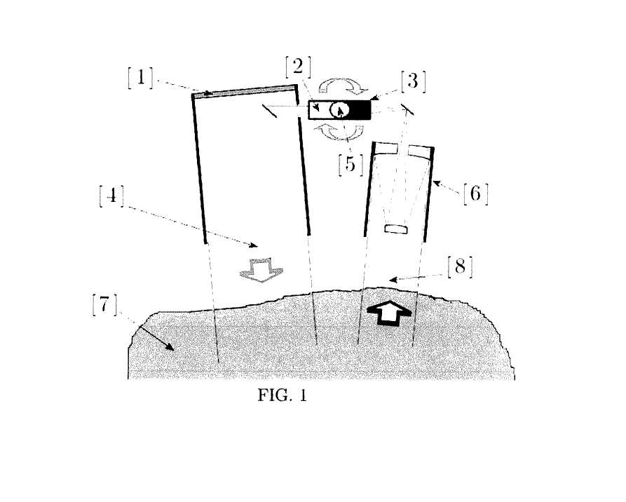

The relatively slowly varying modulation of chirp frequency then allows different reflectors to be resolved in the result χ_{ch}(t) due to the shape the signal autocorrelation function α(λ) (calculated from Eqn. 6). The disadvantage of this is that the resolution and accuracy is limited by the form of this auto-correlation function and its side-lobes as shown in FIG. (a). Interference between the signals from different reflective targets close to each other can hence create false reflection indicators as shown in FIG. 1). In the case of LIDAR, the reflector amplitude measurement may need to be of around 1% accuracy, in order to determine atmospheric trace gas content. Chirp auto-correlation determination of reflector peak amplitudes may not therefore meet needed accuracy specifications.

A highly accurate way to determine the amplitude of a CW signal at a known frequency is to use a LOCKIN amplifier. In the case of a wanted signal of amplitude A at that frequency ωᵣ, the return result V(t) is simply multiplied with a computer generated sine and cosine wave also of frequency ωᵣ, then integrated over an integer number ‘q’ of oscillation periods:

$$\begin{matrix}{S}_{lc} ( t ) = A \times cos \{ {ω}_{r} t + φ \} & ( 7 ) \\ R ( t ) = R \times δ ( t - {t}_{r} ) & ( 8 ) \\ τ = t - d t & ( 9 ) \\ V ( τ ) = G \times A \times R \times cos \{ {ω}_{r} ( τ - {τ}_{r} ) + φ \} & ( 10 ) \\ \begin{matrix}Q = \frac{{ω}_{r}}{q π} \times {\int }_{0}^{2 π q / {ω}_{r}} V ( τ ) \times cos \{ {ω}_{r} τ \} d τ & \\ = G \times A \times R \times cos \{ φ - {ω}_{r} {τ}_{r} \} & ( 12 )\end{matrix} & ( 11 ) \\ \begin{matrix}I = \frac{{ω}_{r}}{q π} \times {\int }_{0}^{2 π q / {ω}_{r}} V ( τ ) \times sin \{ {ω}_{r} τ \} d τ & \\ = - G \times A \times R \times sin \{ φ - {ω}_{r} {τ}_{r} \} & ( 14 )\end{matrix} & ( 13 ) \\ \sqrt{{Q}_{2} + {I}^{2}} = G \times A \times R & ( 15 )\end{matrix}$$

Given knowledge of original amplitude A and receiving detector gain G, a LOCKIN integration over time can provide a highly accurate measure of reflectivity R using Eqns. 11 to 15 (where the signal V(t) is sampled after an interval of time dt beyond transmission, at adjusted time T as in Eqn. 9). This is identical to the use of digital Fourier transforms if the number of samples M in the section of data analyzed is chosen to be an integer number m times the period of the chosen frequency (i.e. M=2πm/ωᵣ).

$$\begin{matrix}y ( ω ) = f t \{ y ( τ ) \} & ( 16 ) \\ {S}_{lc} ( ω ) = \frac{A}{2} [ δ ( ω - {ω}_{r} ) + δ ( ω + {ω}_{r} ) ] {e}^{i ( φ / {ω}_{r} ) ω} & ( 17 ) \\ R ( ω ) = {Re}^{- {iτ}_{r} ω} & ( 18 ) \\ V ( ω ) = \frac{G \times A \times R}{2} [ δ ( ω - {ω}_{r} ) + δ ( ω + {ω}_{r} ) ] {e}^{i ( φ / {ω}_{r} + {τ}_{r} ) ω} & ( 19 )\end{matrix}$$

In such a case the result of a LOCKIN amplifier can be duplicated by examination of the digital result V(ωᵣ) after a Fourier transform ft{ } (as shown in Eqn. 16 for general function of adjusted time γ(τ)). Then the reflector amplitude R is found simply as the absolute value of ∥2V(ωᵣ)/(G×A)∥ based on the digital result V(ωᵣ) from Eqn. 19 (where sample r=0.5Mωᵣ/ωₛ and ωₛ is the digital sampling frequency). However, targets such as the ground or atmosphere contain many reflective surfaces in practice, making the true reflection R(t) the result of Eqn. 20 (where P is the number of different reflectors):

$$\begin{matrix}R ( t ) = {\sum }_{j = 1}^{P} {R}_{j} \times δ ( t - {t}_{j} ) & ( 20 ) \\ \frac{2 V ( {ω}_{r} )}{G \times A} = {\sum }_{j = 1}^{P} {R}_{j} {e}^{i ( φ / {ω}_{r} - {τ}_{j} )} & ( 21 )\end{matrix}$$

Here the use of a standard LOCKIN technique gives a result that represents a sum from all P reflectors the wave has encountered, each with their unknown phase amplitude as a factor. This limits the use of standard LOCKIN amplifiers and CW signals in seismic imaging or LIDAR profiling.

This section introduces methodology that shows how a number P of different reflectors within the profile R(t) can be resolved using specific frequency content design of the used CW signal. This output is made as a summation of P waves at separate frequencies ωₖ, each separated by a fixed difference Δω. This is required to resolve P different reflective surface in R(t) at a spatial resolution of c/π×ωₛ (where c is the speed of light or sound and the frequency spacing Δω=ωₛ/2×P). This signal[4] S_{cω}(t) (Eqn. 22) is transmitted towards the medium[7] to be probed as in FIG. 1. The mathematical values of φₖ in Eqn. 22 are randomly chosen to prevent large constructive or destructive interference. Again as in FIG. 1, next to the transmitter[1] is a receiving telescope[6] which focuses the return signal onto the primary detector[3] (shown in black and is also capable of rotating[5] to exchange places with the reference detector[2] in white). All received signals are sampled for a period T, designed specifically to sample an integer number ‘f’ of times the frequency interval (i.e. T=2πf/Δω and f is known as the oversampling factor). For calibration purposes and prior to beginning sounding measurements, the primary detector[3] (in black in FIG. 1 with its frequency dependent gain Gₖ) is held in the rotated position to view the raw transmission from the left and record the signal ν(t)′ as in Eqn. 23. Calibration of this primary detector uses the Fourier transform of ν(t)′, which is then sub-sampled in the frequency domain based on the chosen over sampling factor f (see Eqn. 25 and FIG. which shows a graphical representation of this LOCKIN sub-sampling to select only chosen frequencies ωₖ and set all other data to zero as noise).

$$\begin{matrix}{S}_{c ω} ( t ) = {\sum }_{k = 1}^{P} {A}_{k} \times cos \{ {ω}_{k} t + {φ}_{k} \} & ( 22 ) \\ {v ( t )}^{′} = {\sum }_{k = 1}^{P} {G}_{k} \times {A}_{k} \times cos \{ {ω}_{k} t + {φ}_{k}^{′} \} & ( 23 ) \\ 2 {v ( ω )}^{′} = {\sum }_{k = 1}^{P} {G}_{k} \times {A}_{k} \times [ δ ( ω - {ω}_{k} ) + δ ( ω + {ω}_{k} ) ] {e}^{i ( {φ}_{k}^{′} / {ω}_{k} ) ω} & ( 24 ) \\ \begin{matrix}2 {v}_{k}^{′} = {v ( {ω}_{fk} )}^{′} & \\ = {G}_{k} \times {A}_{k} {e}^{{iφ}_{k}^{′}} & ( 26 )\end{matrix} & ( 25 ) \\ v ( t ) = {\sum }_{k = 1}^{P} {g}_{k} \times {A}_{k} \times cos \{ {ω}_{k} t + {φ}_{k} \} & ( 27 ) \\ 2 v ( ω ) = {\sum }_{k = 1}^{P} {g}_{k} \times {A}_{k} \times [ δ ( ω - {ω}_{k} ) + δ ( ω + {ω}_{k} ) ] {e}^{i ( {φ}_{k} / {ω}_{k} ) ω} & ( 28 ) \\ \begin{matrix}2 {v}_{k} = v ( {ω}_{fk} ) & \\ = {g}_{k} \times {A}_{k} {e}^{{iφ}_{k}} & ( 30 )\end{matrix} & ( 29 ) \\ \begin{matrix}{ϒ}_{k} = ‖ \frac{{v}_{k}^{′}}{{v}_{k}} ‖ & \\ = \frac{{G}_{k}}{{g}_{k}} & ( 32 )\end{matrix} & ( 31 )\end{matrix}$$

Once ν′ₖ is recorded from the primary detector at frequencies ωₖ, the detector gimbal mount rotates to allow the reference detector[2] (FIG. 1 in white) to immediately sample the same output signal as ν(t) (at new relative phases φₖ, offset from the φ′ₖ values seen in the primary detector calibration period). This completes the calibration of the instrumentation, allowing the sounding of the medium R(t) to begin. The same sub sampling then generates the result νₖ as in Eqn. 29. The magnitude Yₖ of Eqn. 31 hence gives the gain ratio between primary and reference detectors as in Eqn. 32.

$$\begin{matrix}R ( t ) = {\sum }_{j = 1}^{P} {R}_{j} \times δ ( t - {t}_{j} ) & ( 33 ) \\ τ = t - d t & ( 34 ) \\ V ( τ ) = {\sum }_{k = 1}^{P} {G}_{k} \times {A}_{k} {\sum }_{j = 1}^{P} {R}_{j} \times cos \{ {ω}_{k} ( τ - {τ}_{j} ) + {φ}_{k} \} & ( 35 ) \\ V ( ω ) = f t \{ V ( τ ) \} & ( 36 ) \\ \begin{matrix}{V}_{k} = V ( {ω}_{fk} ) & \\ = {G}_{k} \times {A}_{k} {e}^{{iφ}_{k}} {\sum }_{j = 1}^{P} {R}_{j} {e}^{- {iω}_{k} {τ}_{j}} & ( 38 )\end{matrix} & ( 37 ) \\ {Z}_{j} = f t \{ \frac{{V}_{k} \times [ cos \{ {ω}_{k} {τ}_{g} \} + i \cdot sin \{ {ω}_{k} {τ}_{g} \} ]}{{ϒ}_{k} \times {v}_{k}} \} & ( 39 ) \\ {R}_{i} = {Z}_{i} - {( \overline{\{ {Z}_{j} \}} )}_{space} & ( 40 )\end{matrix}$$

Also now the sounding measurement V(τ) is made and transferred to the digital frequency domain to give the sub-sampled result Vₖ as in Eqn. 38. For convenience in the retrieved profile, it is beneficial to know the two way travel time t_{g} from the transmitter to the ground (or seabed, hence giving τ₉ from Eqn. 34). An estimate of the reflective profile shape Zⱼ is then found using Eqn. 39, which de-convolves the transmitted output signal from the return measurement. A LOCKIN method typically does not allow the use of zero frequency signals, so the result Zⱼ will incorrectly also have a mean value also of zero. In order to retrieve the zero Fourier component, an effective “space clamp” is required by averaging the result of Eqn. 39 in a region known to be devoid of reflectors (e.g. areas of insignificant atmospheric content just below the high flying or orbiting sensor) This gives the value of \overline{{Zⱼ}}_{space}, as illustrated in FIG. (b), then the final result Rⱼ is obtained from Eqn. 40 after space clamp subtraction.

This final section shows simulations of results for atmospheric LIDAR sounding using chirp, pulse and LOCKIN imaging techniques and a signal to noise ratio set at around 1:1. The scenario is for a low Earth orbiting satellite at an altitude of 450 km moving at 7.5 km/s. LIDAR is used to image multilayered clouds of horizontal size 3.75 km and thickness 375 m. For purposes of resolution evaluation, the 2 dimensional cloud field is also made to take the form of a checkerboard (see FIG.). The LIDAR will be required to make ten atmospheric soundings per second, to resolve clouds at a horizontal resolution of 750 m. The sampling frequency ω, will be 2 MHz, with a need to resolve 2500 atmospheric reflectors (i.e. P=2500, Δω=400 Hz, f=40 and T=0.1 s).

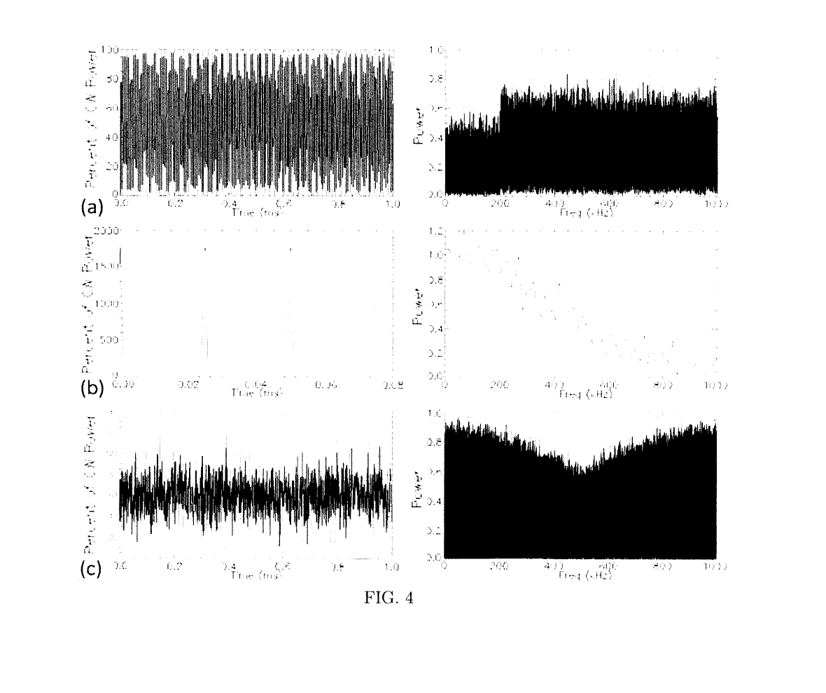

The chosen chirp signal S_{ch}(l) sweeps from 0.2-1 MHz every 0.1 seconds as shown in FIG. 4(a) with a random noise signal artificially added that is of a power magnitude equal to that generated by cosines (i.e. SNR=1, see noise amplitude on right of FIG. 4(a) and FIG. (a) for the corresponding auto-correlation function α(λ) from Eqn. 6).

FIG. 4(b) shows the form of the chosen pulse laser, lasting for a duration of 1 μs and repeating at 40 kHz. Note that this requires 15-20 times the power used in the CW chirp laser above (hence the lower relative noise amplitude seen in the Fourier domain on right).

Finally FIG. 4(c) displays the combined 2500 frequencies used in the LOCKIN imaging signal. As with the chirp waveform, the power used here is over an order of magnitude less than that required for the pulse laser (again resulting in a SNR of 1:1 as shown in FIG. 4(c) right).

The thick black dashed curve in FIG. (c) shows an example of the ideal cross-section of the simulated checkerboard cloud field being probed on one 0.1 second sounding. FIG. (b) above displays the raw result Zⱼ from Eqn. 39 before the space clamp is applied. After subtraction of this offset, the retrieved LOCKIN R(t) profile is overlaid in solid grey over the perfect signal in FIG. (c). The dotted curve on the same graph shows the retrieval from the chirp auto correlation and the dashed grey profile is that retrieved from the pulse laser.

With its greater power, the pulse retrieval is the cleanest signal compared to the other CW techniques. However, the finite pulse bandwidth leads to incorrect measurements of the cloud field amplitudes for such high spatial frequency targets positioned so close together. The chirp profile (in dots) also has significant in-accuracies in the retrieved amplitudes of the cloud field, in addition to greater noise. The LOCKIN imaging result does manage to recover the high spatial frequency structure of the checkerboard cloud field, albeit with greater noise than for the far more powerful pulse laser. FIG. (left) shows two dimensional images of these cloud field retrievals for the three different techniques, with maps of the associated errors displayed to the right. The top chirp image has significant random errors and biases, no doubt due to the effects of the auto-correlation side-lobes (FIG. (a)). The pulse laser cloud field (middle left) is of greater clarity than that for the chirp signal above but the errors on the right indicate substantial biases caused by the finite pulse bandwidth (leading to an overall RMS error of over 13%).

As expected from FIG. (b) & (c), the LOCKIN imaging method results in the most clarity of the retrieved cloud fields and the lowest overall RMS error of around 1% (for a SNR of 1, see FIG. (bottom)).

The presented LOCKIN imaging method has the potential to allow greater accuracy in sounding retrievals and hence a lower power requirement for seismic or LIDAR systems. In contrast to pulse or chirp techniques, the accuracy and resolution of the data here is defined by the bandwidth theorem and the choice of oversampling factor f. Hence in order to obtain better quality results, theory suggests that longer sampling intervals T and smaller frequency steps Δω need only be used (with the acknowledged penalty of longer periods needed for the sounding).

It should also be mentioned that for the field of seismics, extra factors may need consideration such as the greater attenuation of higher sound frequencies within water and the ground. This can be compensated for by carefully designed exponential high frequency amplification in the Fourier domain of result Vₖ from Eqn. 38. This process could be aided by the addition of extra tones within the transmitted signal (e.g. at intermediate sound frequencies at (ωₖ+ωₖ₊₁)/2, allowing iteration of the high frequency amplification curve to obtain consistent R(t) retrievals for both initially chosen and intermediate tones. Extra tones would also facilitate offline laser wavelengths for DIAL LIDAR sounding.

Finally it should be considered that practical generation of a signal modulated at frequencies ωₖ may involve a typical error dω, which will have impacts on the data accuracy. With the speed of current processors, this can be compensated for by use of simple factors e^{idω.t} to the sampled signals of V(τ) and ν(τ) (i.e. to prevent creating an extremely low νₖ value for use in the denominator of Eqn. 39)

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A system sounding a medium to be probed using a continuous wave signal comprising:
A transducer for generating the continuous wave signal and,
a receiving telescope to collect the signal reflected from the medium to be probed, and
the transmitted signal is specifically designed in the frequency domain to allow the described digital LOCKIN imaging technique to be employed and,
the signal therefore to consist a an integer number of specific frequencies separated by a fixed wavelength interval Δω and,
these frequencies are chosen in these steps to fully cover the total frequency response of the instrumentation used.

2. The method of claim 1 wherein
the continuous wave signal is constructed by an integer number of separate frequencies separated by wavelength interval Δω so to cover the full spectral range of the instrumentation being used.

3. The method of claim 1 wherein
The continuous wave signal consists of P separate frequencies to cover the sampling frequency range ωₛ/2 where P is a positive integer an ωₛ is the instrumentation sampling frequency.

4. The method of claim 3 wherein
both the resolution and accuracy of retrieved continuous wave data is comparable to that of a higher power pulse sounding system.

5. The method of claim 3 wherein
the continuous wave signal is sampled upon both transmission and reception by two separate detectors each with an appropriate frequency response.

6. The method of claim 3 wherein
the reference detectors that separately sample transmitted and received continuous wave signals are capable of being alternated to measure either signal.

7. The method of claim 3 wherein
the transmitted signal is generated by an appropriate transducer capable of movements above the medium to be probed.

8. The method of claim 1 wherein
upon reception of transmitted or returned signals the data is digitized using appropriate A/D conversion

9. The method of claim 1 wherein
such A/D conversion is performed with sufficient bit length to enable accurate determination of wave amplitudes by appropriate software to perform digital signal processing.

10. Digital signal processing comprising of:
front end analogue to digital converter, and processor with sufficient speed to perform analysis in real-time.

11. A method of sounding a medium using low energy continuous wave signals comprising the steps of:
digital to analogue conversion of a digital signal with specifically designed frequency content;
transmission to medium to be probed from a transducer capable of movement across the medium;
sampling of this transmitted signal via a reference detector at the transducer by appropriate analogue to digital devices;
reception of the reflected signal from the medium by an appropriate telescope;
the capability to swap such transmission and reception reference detectors;
sampling of this returned signal via a separate reference detector at the telescope by appropriate analogue to digital devices;
and appropriate on-board processor capable of digital signal processing on the recorded signal in real-time.
